(19) United States
(12) Patent Application Publication
(10) Pub. No.: US 2014/0327906 A1
(43) Pub. Date: Nov. 6, 2014

(54) SYSTEM AND METHOD FOR MAINTAINING OPTICS IN FOCUS

(71) Applicant: CAMTEK LTD., Migdal Haemek (IL)

(72) Inventors: Guy Kafry, Atzmon (IL); Arnon Ben-Natan, Kiryat Tiv'on (IL)

(73) Assignee: CAMTEK LTD., Migdal Haemek (IL)

(21) Appl. No.: 14/269,156

(22) Filed: May 4, 2014

Related U.S. Application Data
(60) Provisional application No. 61/819,694, filed on May 6, 2013.

(51) Int. Cl. G01N 21/13; G01N 21/88

(52) U.S. Cl. CPC G01N 21/13; G01N 21/88
USPC 356/244

(57) ABSTRACT

According to an embodiment of the invention there is provided a system that may include a pivot chuck that may include : a lower chuck portion; an upper chuck portion; a first distance changing module that may include a pivot mechanism and an angle changing element; wherein the pivot mechanism pivotally couples the lower chuck portion to the upper chuck portion; wherein the angle changing element is coupled between the upper and lower chuck portions; wherein the upper chuck portion may be arranged to support a substrate; wherein the angle changing element may be arranged to induce a rotation of the upper chuck portion in relation to the pivot mechanism in response to first focus correction signals.

### RELATED APPLICATIONS

This application claims priority from U.S. provisional patent Ser. No. 61/819694 filing date May 6 2013 which is incorporated herein by reference.

### BACKGROUND OF THE INVENTION

Objects such as silicon wafers, printed circuit boards, reticules, flat panel display or other substrate shaped objects are inspected by high resolution inspection systems that include optics that have a limited depth of field.

The inspection process involves scanning the objects while the objects are supported by a chuck. The objects are not ideally flat and their deviation from flatness may exceed by magnitude the depth of field.

There is a need to provide a system with auto-focus capabilities.

### SUMMARY

According to an embodiment of the invention there is provided a system that may include a pivot chuck that may include : a lower chuck portion; an upper chuck portion; a first distance changing module that may include a pivot mechanism and an angle changing element; wherein the pivot mechanism pivotally couples the lower chuck portion to the upper chuck portion; wherein the angle changing element is coupled between the upper and lower chuck portions; wherein the upper chuck portion may be arranged to support a substrate; wherein the angle changing element may be arranged to induce a rotation of the upper chuck portion in relation to the pivot mechanism in response to first focus correction signals.

The system may include a second distance changing module that may be arranged to change a distance between the pivot chuck and optics in response to second focus correction signals.

A maximal distance correction introduced by the second distance changing module exceeds a maximal distance correction introduced by the first distance changing module.

The system may include optics and a sensor that may be arranged to (i) sense deviation of optics focus and (ii) generate the first and second focus correction signals.

The second distance changing module may be arranged to change a height of the optics.

The second distance changing module may be arranged to change a height of the optics and a height of the pivot chuck.

The joint mechanism defines a pivot point and wherein the second distance changing module may be arranged to change the distance between the pivot chuck and the optics until a point of the substrate that is immediately above the pivot point is located at a focal point of the optics.

The system may include a memory unit that may be arranged to store first focus correction signals that were generated during a certain scan of the substrate; and wherein the system may be arranged to feed the first focus correction signals to the first distance changing module during a another scan of the substrate.

The joint mechanism defines a pivot point that is positioned at a center of the upper chuck portion.

The joint mechanism defines a pivot point that is positioned outside a center of the upper chuck portion.

The joint mechanism defines a pivot point; wherein a ratio between (a) a first distance between the pivot point and a center of the upper chuck portion, and (b) a second distance between the pivot point and an edge of the upper chuck portion ranges between 0.1 and 10.

The system may include at least one additional angle changing element arranged to induce the rotation of the upper chuck portion in relation to the pivot mechanism in response to focus correction signals.

The angle changing element is a piezoelectric actuator.

An auto-focus method, the method may include : sensing, by a sensor, a deviation from focus of optics; and inducing, by an angle changing element, a rotation of an upper chuck portion in relation to a pivot mechanism that pivotally couples a lower chuck portion to the upper chuck portion; wherein the upper chuck portion may be arranged to support a substrate.

The method according to may include changing, by a second distance changing module, a distance between the pivot chuck and optics in response to second focus correction signals.

The method according to wherein a maximal distance correction introduced by the second distance changing module exceeds a maximal distance correction introduced by the first distance changing module.

The method may include sensing by a sensor deviation of optics focus and generating the first and second focus correction signals.

The method may include changing by the second distance changing module a height of the optics.

The method may include changing by the second distance changing module a height of the optics and a height of the pivot chuck.

The joint mechanism defines a pivot point and wherein the method may include changing by the second distance changing module the distance between the pivot chuck and the optics until a point of the substrate that is immediately above the pivot point is located at a focal point of the optics.

The method may include storing by a memory module first focus correction signals that were generated during a certain scan of the substrate; and feeding the first focus correction signals to the first distance changing module during another scan of the substrate.

The joint mechanism defines a pivot point that is positioned at a center of the upper chuck portion.

The joint mechanism defines a pivot point that is positioned outside a center of the upper chuck portion.

The joint mechanism defines a pivot point; wherein a ratio between (a) a first distance between the pivot point and a center of the upper chuck portion, and (b) a second distance between the pivot point and an edge of the upper chuck portion ranges between 0.1 and 10.

The method according to wherein the inducing of the rotation of the upper chuck portion is performed by the angle changing element and by at least one other angle changing element.

The angle changing element is a piezoelectric actuator.

### BRIEF DESCRIPTION OF THE INVENTION

The present invention will be understood and appreciated more fully from the following detailed description taken in conjunction with the drawings in which:

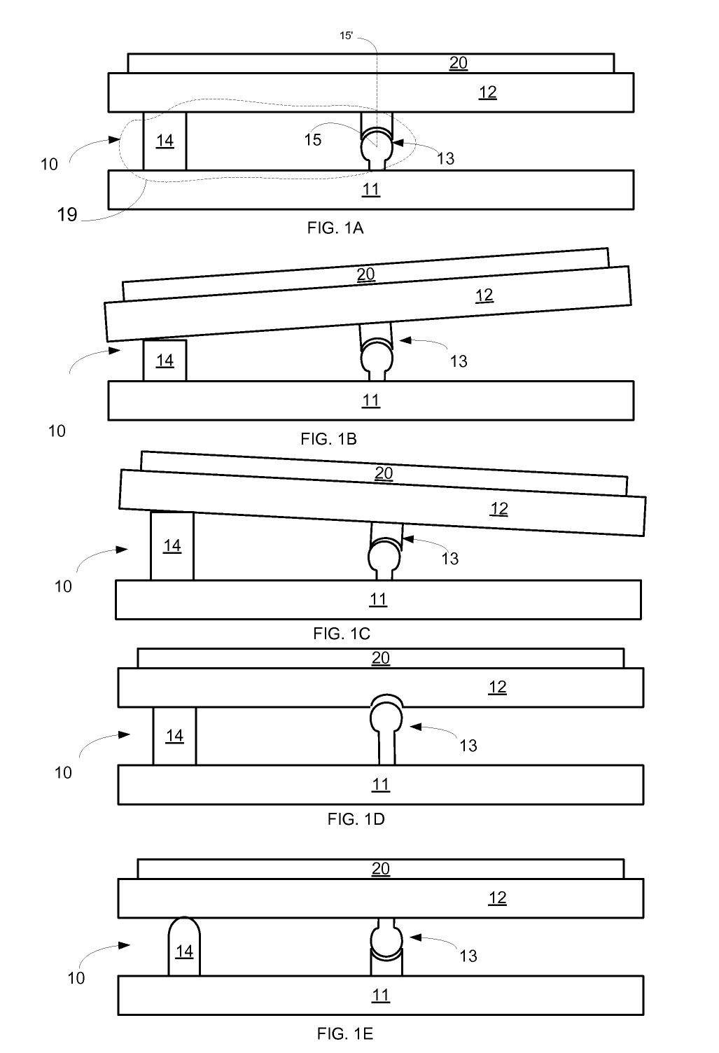

FIGS. 1A-1E illustrate a pivot chuck and a substrate according to at least one embodiment of the invention;

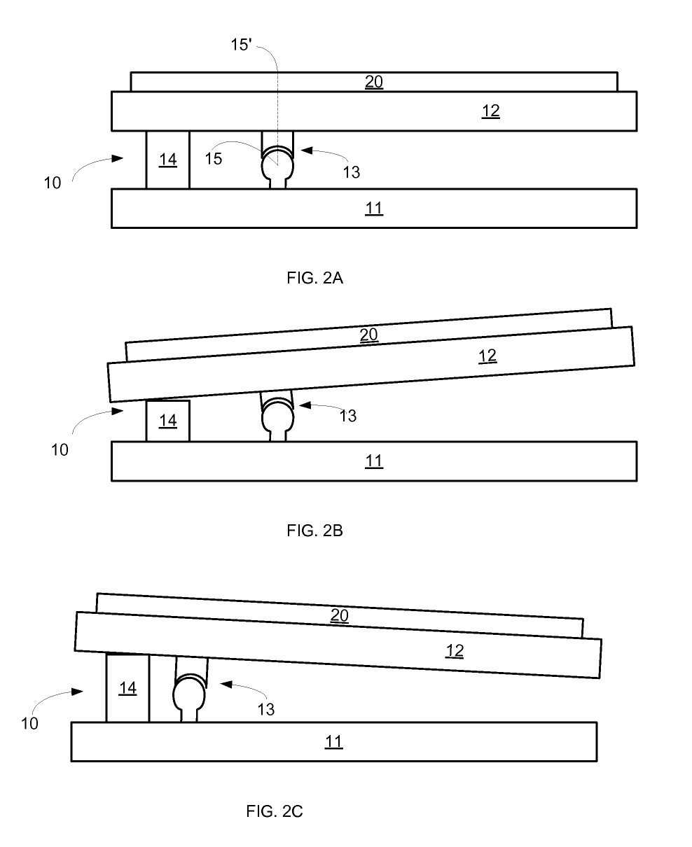

FIGS. 2A-2C illustrate a pivot chuck and a substrate according to at least one embodiment of the invention;

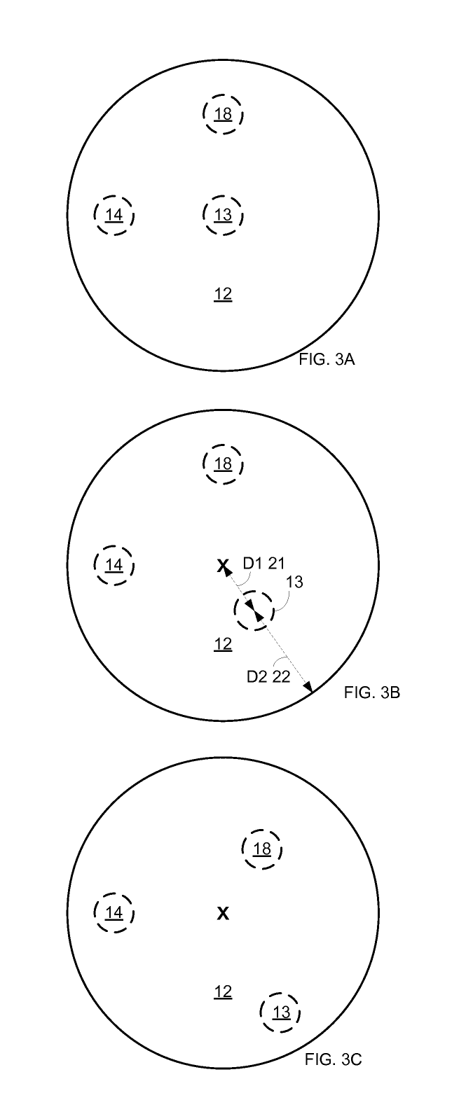

FIGS. 3A-3C illustrate a chuck upper portion , a center of the chuck upper portion, a pivot mechanism and two angle changing elements according to at least one embodiment of the invention;

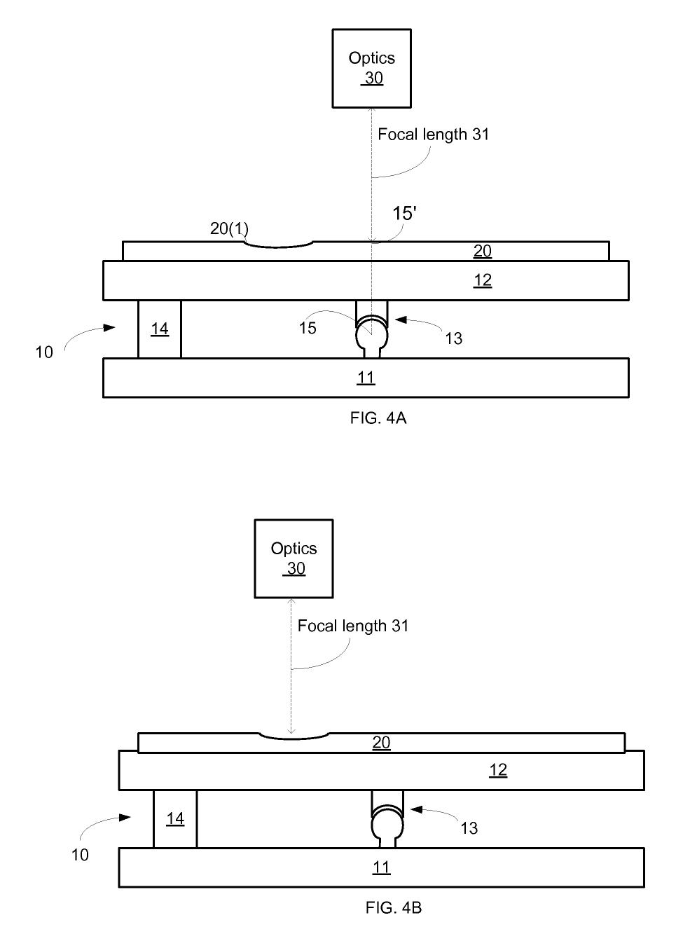

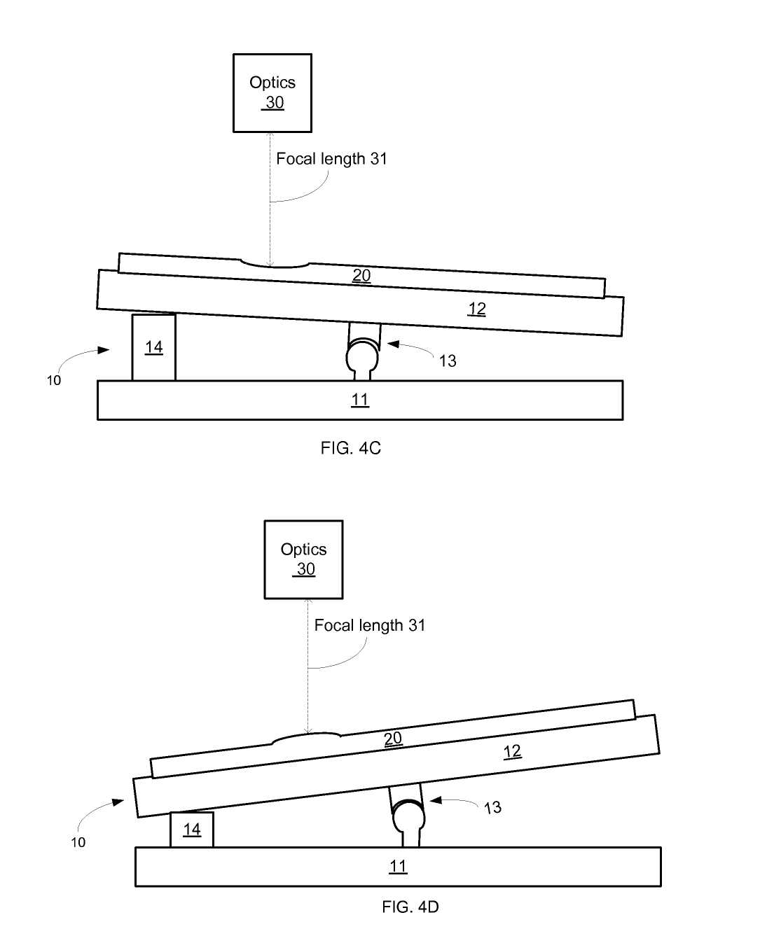

FIGS. 4A-4D illustrate a pivot chuck and a substrate according to at least one embodiment of the invention;

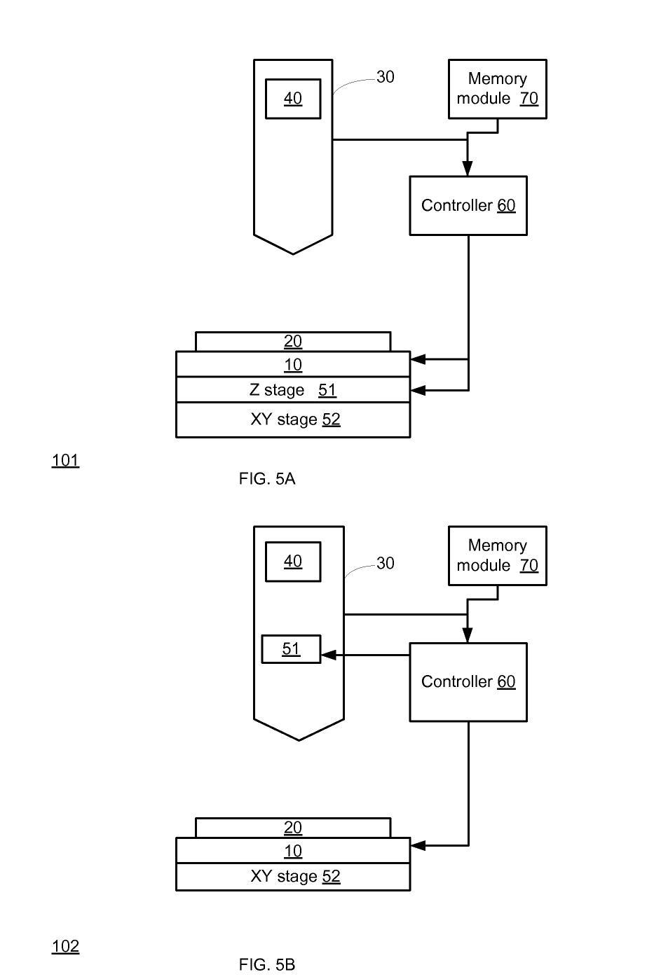

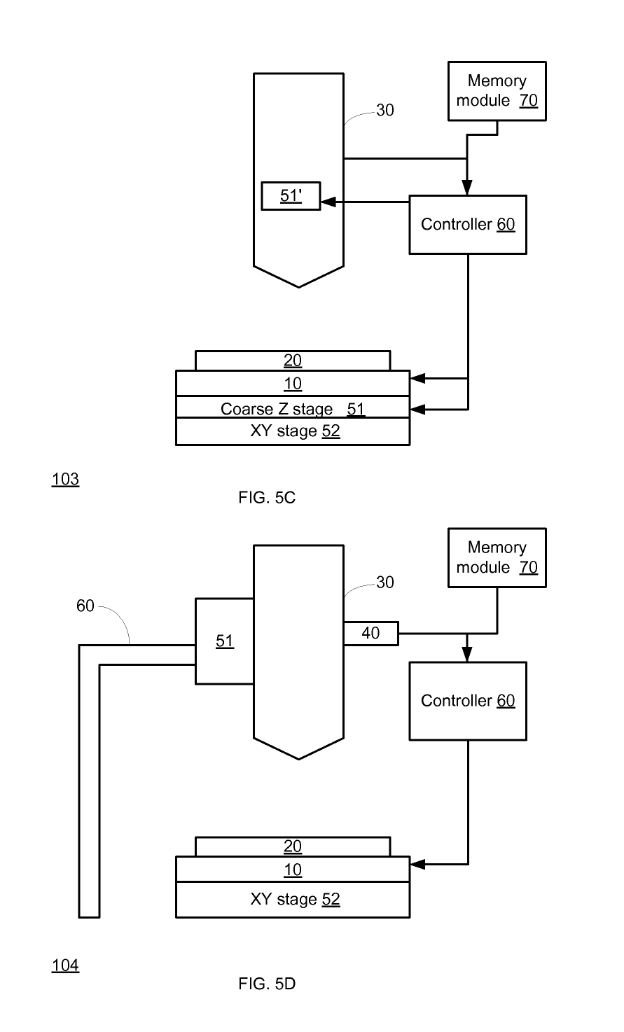

FIGS. 5A-5D illustrate a substrate and system that includes a pivot chuck according to at least one embodiment of the invention;

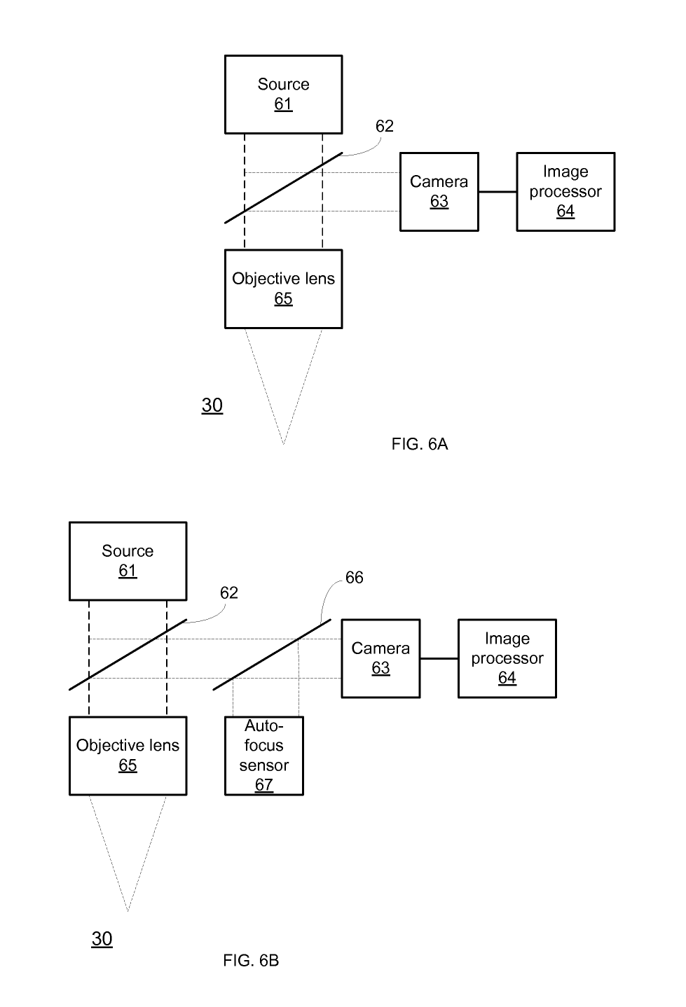

FIGS. 6A-6B illustrate optics according to at least one embodiment of the invention; and

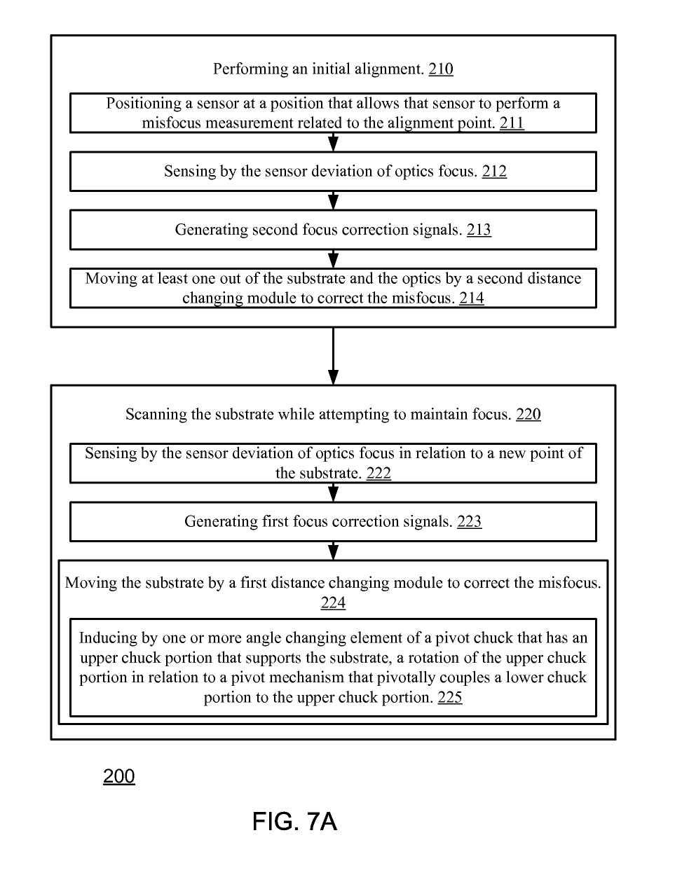

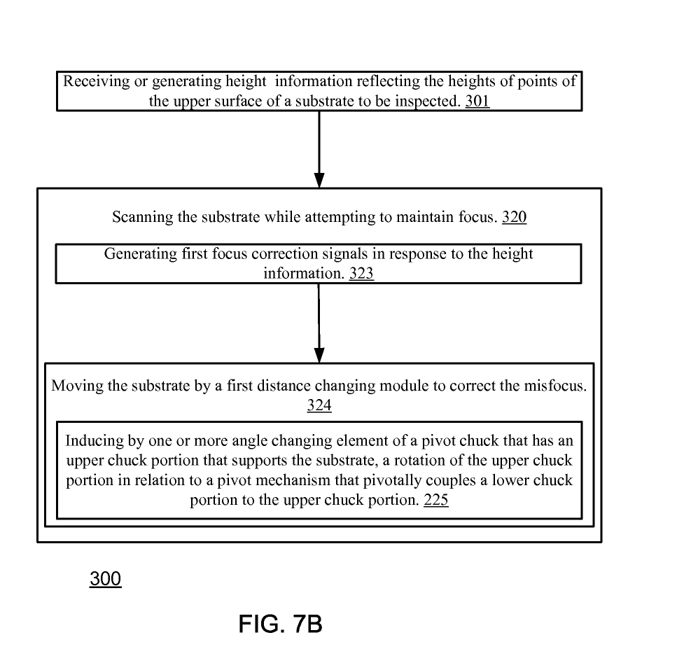

FIG. 7A-7B illustrate flow charts according to at least one embodiment of the invention.

### DETAILED DESCRIPTION OF THE INVENTION

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention. The drawings may be in scale or out of scale. For example, FIGS. 1A-1E are out of scale.

In the following specification, the invention will be described with reference to specific examples of embodiments of the invention. It will, however, be evident that various modifications and changes may be made therein without departing from the broader spirit and scope of the invention as set forth in the appended claims.

There is provided a system that may include a pivot chuck, a method and a pivot chuck.

The following description assumes that the optics are positioned above the substrate and that the distance between the optics and the substrate (or a distance between the optics and a point of interest of the substrate to be viewed by the optics) equals the height differences between the optics and the substrate. Accordingly—focus correction involves changing the relative height of the optics, the substrate (or the substrate point of interest) or both. Assuming that the substrate is located in an imaginary XY plane, the height changes may occur along the Z axis.

A pivot chuck is a chuck that includes a pivot mechanism that allows an upper portion of the chuck to pivot in relation to the pivot mechanism and thereby maintain optics in focus. A chuck includes any mechanical element, module, device capable of supporting a substrate.

The pivoting can be perform fine distance corrections. Coarser distance corrections an be provided by another mechanism such as a Z-stage. Additionally or alternatively, the Z-stage may provide finer distance changes or distance changes that are substantially equal to those provided by the pivot chuck.

It is noted that using fine and coarse distance correction mechanisms provides both fine height corrections and also a large range of height corrections.

FIG. 1A illustrates a pivot chuck 10 that supports a substrate 20 according to an embodiment of the invention.

The pivot chuck 10 includes pivot mechanism 13 that allows an upper chuck portion 12 to pivot in relation to the pivot mechanism 13 and thereby maintain optics (not shown) in focus. FIG. 1A also shows the lower chuck portion 20. Both lower and upper chuck portions are horizontal.

The pivot mechanism 13 may be a pivot joint or any other mechanism that allows a rotation of one end of the pivot mechanism in relation to another end of the pivot mechanism.

A first distance changing module 19 is formed by the pivot mechanism 13 and the angle changing element 14.

FIG. 1A illustrates a pivot mechanism 13 that includes a lower part that has a ball-shaped upper end and an upper part that has a concave lower end that matches the ball-shaped upper end.

FIG. 1A also shows an angle changing element 14 that is positioned between the upper and lower chuck portions 12 and 11 and is arranged to induce a rotation of the upper chuck portion 12 in relation to the pivot mechanism 13 in response to first focus correction signals.

The angle changing element 14 may change its height and thereby allow the rotation between the upper and lower chuck portions 12 and 11. It may be a piezoelectric actuator or motor or any other element with controllable height.

The rotation of the upper chuck portion changes the distance between the optics and a substrate point of interest thereby placing the substrate point of interest at the focal point of optics (not shown) thereby maintaining focus.

FIG. 1A also illustrates a pivot point 15 and a point 15′ of the substrate that is located immediately above the pivot point. The pivot point is defined by the pivot mechanism 13.

FIG. 1B illustrates a pivot chuck 10 that supports a substrate 20 according to an embodiment of the invention. FIG. 1B differs from FIG. 1A by having the upper chuck portion 12 tilted to the left so that its left end is lower than its right end.

FIG. 1C illustrates a pivot chuck 10 that supports a substrate 20 according to an embodiment of the invention. FIG. 1C differs from FIG. 1A by having the upper chuck portion 12 tilted to the right so that its left end is higher than its right end.

FIG. 1D illustrates a pivot chuck 10 that supports a substrate 20 according to an embodiment of the invention. FIG. 1D differs from FIG. 1A by its pivot mechanism—as the upper chuck portion 12 has a concave portion that matches a ball ended part of the pivot mechanism.

FIG. 1E illustrates a pivot chuck 10 that supports a substrate 20 according to an embodiment of the invention. FIG. 1E differs from FIG. 1A by its pivot mechanism—

The upper part has a ball-shaped lower end and an lower part that has a concave upper end that matches the ball-shaped upper end.

The pivot mechanism may be integrated with one of the portions of the pivot chuck.

In FIGS. 1A-1E the pivot mechanism was positioned at (or near) the center of the chuck—it is located at substantially the same distance from opposite ends of the pivot chuck. In this configuration the pivot mechanism 13 is bears a substantial portion of the weight of the substrate (assuming that the pivot chuck and the substrate are coaxial)—and reduced the weight to be carried by the angle changing element. For example, when there are two angle changing element the pivot mechanism carries one third of the weight of the substrate. This reduced the overall weight to be supported by the angle changing element and allows using either cheaper and/or faster angle changing element in comparison to a state in which the pivot mechanism is located outside the center of the shuck 10—as illustrated in FIGS. 2A-2C.

FIG. 2A illustrates a pivot chuck 10 that supports a substrate 20 according to an embodiment of the invention. FIG. 2A differs from FIG. 1A by having a pivot mechanism 13 that is positioned outside the center of the substrate 20.

FIG. 2B illustrates a pivot chuck 10 that supports a substrate 20 according to an embodiment of the invention. FIG. 2B differs from FIG. 2A by having the upper chuck portion 12 tilted to the left so that its left end is lower than its right end.

FIG. 2C illustrates a pivot chuck 10 that supports a substrate 20 according to an embodiment of the invention. FIG. 2C differs from FIG. 2A by having the upper chuck portion 12 tilted to the right so that its left end is higher than its right end.

Positioning the pivoting mechanism outside the center of the substrate may reduce the weight carried by it but may reduce the distance between it and he edge of the substrate and thus result in a greater angular compensation range provided by it.

FIGS. 3A-3C illustrate a chuck upper portion 12, a center (denoted by “X”) of the chuck upper portion 12, a pivot mechanism 13 and two angle changing elements 14 and 18 according to at least one embodiment of the invention.

These figures provide a top view of the chuck upper portion 12. The pivot mechanism 13 and the two angle changing elements 14 and 18 are below the chuck upper portion 12 and are shown by dashed lines.

FIG. 3A illustrates the pivot mechanism 13 as being positioned at the center of the chuck upper portion 12.

FIG. 3B illustrates the pivot mechanism 13 as being positioned outside the center of the chuck upper portion 12—but closer to the center than to the edge of the chuck upper portion 12. A first distance (D1 21) between the center and the pivot mechanism 13 is smaller than a second distance (D2 22) between the pivot mechanism and the edge of the chuck upper portion 12.

FIG. 3C illustrates the pivot mechanism 13 as being positioned outside the center of the chuck upper portion 12—but closer to the edge than to the center of the chuck upper portion 12.

FIG. 4A illustrates optics 30, and pivot chuck 10 that supports a substrate 20 according to an embodiment of the invention. FIG. 4A differs from FIG. 1A by including optics 30 and by having a substrate 20 that has a concave recess 20(1) formed at its upper surface. It is noted that in FIG. 4A (as in FIG. 1A) both upper and lower chuck portions 11 and 12 are horizontal. FIG. 4A also shows that a point of interest of the substrate positioned immediately above the pivot point 15 is located at the focal length (31) of optics 30.

FIG. 4B illustrates optics 30, and pivot chuck 10 that supports a substrate 20 according to an embodiment of the invention. FIG. 4B differs from FIG. 4A by showing that points to be inspected within the concave recess 20(1) are outside the focal length 31 of optics (out of focus). These points are more distance than the focal length 31.

FIG. 4C illustrates optics 30, and pivot chuck 10 that supports a substrate 20 according to an embodiment of the invention. FIG. 4C differs from FIG. 4B by showing that the upper chuck portion 12 was rotated to the right thereby placing the point within the concave recess 20(1) at the focal length 31 of optics 30- thereby maintaining focus.

FIG. 4D illustrates optics 30, and pivot chuck 10 that supports a substrate 20 according to an embodiment of the invention. FIG. 4D differs from FIG. 4C by showing that the upper chuck portion 12 was rotated to the left thereby placing a point of a convex bump at the focal length 31 of optics 30—thereby maintaining focus.

FIGS. 5A-5D illustrates substrate 20 and systems 101-104 according to various embodiments of the invention.

System 101 of FIG. 5A includes pivot chuck 10, Z stage 51, XY stage 52, controller 60, memory module 70, optics 30 and sensor 40. Pivot chuck 10 is supported by Z-stage 51 and by XY stage 52.

Sensor 40 senses deviation from focus and generates focus correction signals that may be processed by controller 60 to provide first focus correction signals to be provided to pivot chuck 10 and second focus correction signals to be provided to Z stage 51. The processing by controller 60 may include changing the format (modulation, amplitude, phase) of the focus correction signals.

The focus correction signals may be stored at memory module 70. Accordingly—focus correction signals obtained during a first scan of the substrate can be used for further scans of the substrate. Different scans can use the same optical elements of optics or may be used by different optical elements of optics 30.

FIG. 5A illustrates an in-axis configuration in which the sensor 40 is a part of optics 30. In this figure the Z-stage 51 moves the substrate and not optics 30.

Optics 30 may include light source, lenses, beam splitter, collimators or any other radiation manipulating element.

The Z stage 51 may be coarser than a first distance change mechanism formed by pivot mechanism 13 and angle changing elements. The maximal distance correction introduced by the Z stage 51 may be even reach few millimeters, few centimeters (or more) while the first distance change mechanism may introduce smaller height changes—for example it may introduce a maximal distance correction of few hundred microns (for example 400 microns).

System 102 of FIG. 5B includes pivot chuck 10, Z stage 51, XY stage 52, controller 60, memory module 70, optics 30 and sensor 40. Pivot chuck 10 is supported by XY stage 52 and Z stage 51 is a part of optic 30 and is arranged to move components of optics 30 in relation to substrate 20.

System 103 of FIG. 5C includes pivot chuck 10, first and second Z stages 51 and 51′, XY stage 52, controller 60, memory module 70, optics 30 and a sensor (not shown). Pivot chuck 10 is supported by XY stage 52 and first Z stage 51. Second Z stage 51′ is a part of optic 30 and is arranged to move components of optics 30 in relation to substrate 20.

System 104 of FIG. 5D includes pivot chuck 10, Z stage 51, XY stage 52, controller 60, memory module 70, optics 30, sensor 40 and structural element 70. Pivot chuck 10 is supported by XY stage. Z stage 51 is connected between optics 30 and structural element 70 and is arranged to move optics 30 in relation to substrate 20. Sensor 40 is located off-axis—it has an optical axis that differs from the optical axis of optics 30.

Using a Z-stage and pivot stage 10 below the substrate 20 (as illustrated, for example, in FIGS. 5A and 5D) may reduce substrate contamination.

FIGS. 6A-6B illustrate optics 30 according to at least one embodiment of the invention.

Optics 30 of FIG. 6A includes light source 61, beam splitter 62, objective lens 65, camera 63 and image processor 64. The camera 63 and image processor 64 are used for obtaining inspection images, processing inspection images and also for detecting misfocus and generating focus correction signals.

Optics 30 of FIG. 6B also includes a second beam splitter 66 that diverts light towards a dedicated auto-focus sensor 67.

FIG. 7A illustrates method 200 according to an embodiment of the invention.

Method 200 illustrates distance corrections that are performed in response to real time distance measurements - distance corrections are made in timing proximity to the obtaining of focus parameters that trigger the distance corrections.

Method 200 may start by stage 210 of performing an initial alignment.

The height of a point (denoted 15′ in FIG. 1A) of the substrate that is immediately above the pivot point (denoted 15 in FIG. 1A) does not change as a result of the rotation of the upper chuck portion. This point will be referred to as an alignment point.

The initial alignment 210 may include placing the alignment point at the focal length of the optics. Stage 210 may include positioning (211) a sensor at a position that allows that sensor to perform a misfocus measurement related to the alignment point, sensing (212) by the sensor deviation of optics focus (distance between the alignment point and the focal length of the optics), generating (213) second focus correction signals, and moving (214) at least one out of the substrate and the optics by a second distance changing module to correct the misfocus.

Stage 210 may be followed by stage 220 of scanning the substrate while attempting to maintain focus. The scanning includes imaging one new point (or one area) of the substrate after the other.

Stage 220 may include sensing (222) by the sensor deviation of optics focus in relation to a new point of the substrate, generating (223) first focus correction signals, and moving (224) the substrate by a first distance changing module to correct the misfocus.

The moving (224) of the substrate by the first distance changing module includes inducing (225), by one or more angle changing element of a pivot chuck that has an upper chuck portion that supports the substrate, a rotation of the upper chuck portion in relation to a pivot mechanism that pivotally couples a lower chuck portion to the upper chuck portion.

FIG. 7B illustrates method 300 according to an embodiment of the invention.

Method 300 illustrates distance corrections that are performed in response to non real time distance measurements. These non real time measurements may be obtained a long time (at least few minutes) before making the distance corrections. For example, a height map of the substrate can be generated after one or more scans of the substrate. This height map or a corresponding map of distance correction signals may be stored and used in further scans of the substrate.

Method 300 may start by stage 301 of receiving or generating height information reflecting the heights of points of the upper surface of a substrate to be inspected. The height information may be a height map and/or may include the focus correction signals to be generated when reaching the different points of the substrate.

Stage 301 may include generating the height map during an execution of method 200. It is noted that the height map may be generated by scanning the substrate while measuring misfocus but without misfocus correction. Stage 301 may be followed by stage 210 of initial alignment.

Stage 210 may be followed by stage 320 of scanning the substrate while attempting to maintain focus. The scanning includes imaging one new point (or one area) of the substrate after the other.

Stage 320 may include generating (323) first focus correction signals in response to the height information, and moving (324) the substrate by a first distance changing module to correct the misfocus.

The moving (324) of the substrate by the first distance changing module includes inducing (325), by one or more angle changing element of a pivot chuck that has an upper chuck portion that supports the substrate, a rotation of the upper chuck portion in relation to a pivot mechanism that pivotally couples a lower chuck portion to the upper chuck portion.

Methods 200 and 300 or any combination of stages of these method may be executed by any of the systems of FIGS. 5A-5D.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

However, other modifications, variations, and alternatives are also possible. The specifications and drawings are, accordingly, to be regarded in an illustrative rather than in a restrictive sense.

The word “comprising” does not exclude the presence of other elements or steps then those listed in a claim. It is understood that the terms so used are interchangeable under appropriate circumstances such that the embodiments of the invention described herein are, for example, capable of operation in other orientations than those illustrated or otherwise described herein.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe.

Thus, these terms are not necessarily intended to indicate temporal or other prioritization of such elements. The mere fact that certain measures are recited in mutually different claims does not indicate that a combination of these measures cannot be used to advantage.

We claim:

1. A system, comprising:
a pivot chuck that comprises:
a lower chuck portion;
an upper chuck portion;
a first distance changing module that comprises a pivot mechanism and an angle changing element; wherein the pivot mechanism pivotally couples the lower chuck portion to the upper chuck portion; wherein the angle changing element is coupled between the upper and lower chuck portions;
wherein the upper chuck portion is arranged to support a substrate;
wherein the angle changing element is arranged to induce a rotation of the upper chuck portion in relation to the pivot mechanism in response to first focus correction signals.

2. The system according to claim 1 further comprising a second distance changing module that is arranged to change a distance between the pivot chuck and optics in response to second focus correction signals.

3. The system according to claim 2 wherein a maximal distance correction introduced by the second distance changing module exceeds a maximal distance correction introduced by the first distance changing module.

4. The system according to claim 2 further comprising optics and a sensor that is arranged to (i) sense deviation of optics focus and (ii) generate the first and second focus correction signals.

5. The system according to claim 2 wherein the second distance changing module is arranged to change a height of the optics.

6. The system according to claim 2 wherein the second distance changing module is arranged to change a height of the optics and a height of the pivot chuck.

7. The system according to claim 2 wherein the joint mechanism defines a pivot point and wherein the second distance changing module is arranged to change the distance between the pivot chuck and the optics until a point of the substrate that is immediately above the pivot point is located at a focal point of the optics.

8. The system according to claim 2 further comprising a memory unit that is arranged to store first focus correction signals that were generated during a certain scan of the substrate; and wherein the system is arranged to feed the first focus correction signals to the first distance changing module during a another scan of the substrate.

9. The system according to claim 1 wherein the joint mechanism defines a pivot point that is positioned at a center of the upper chuck portion.

10. The system according to claim 1 wherein the joint mechanism defines a pivot point that is positioned outside a center of the upper chuck portion.

11. The system according to claim 1 wherein the joint mechanism defines a pivot point; wherein a ratio between (a) a first distance between the pivot point and a center of the upper chuck portion, and (b) a second distance between the pivot point and an edge of the upper chuck portion ranges between 0.1 and 10.

12. The system according to claim 1 further comprising at least one additional angle changing element arranged to induce the rotation of the upper chuck portion in relation to the pivot mechanism in response to focus correction signals.

13. The system according to claim 1 wherein the angle changing element is a piezoelectric actuator.

14. An auto-focus method, the method comprises:
sensing, by a sensor, a deviation from focus of optics; and
inducing, by an angle changing element, a rotation of an upper chuck portion in relation to a pivot mechanism that pivotally couples a lower chuck portion to the upper chuck portion; wherein the upper chuck portion is arranged to support a substrate.

15. The method according to claim 14 further comprising changing, by a second distance changing module, a distance between the pivot chuck and optics in response to second focus correction signals.

16. The method according to claim 15 wherein a maximal distance correction introduced by the second distance changing module exceeds a maximal distance correction introduced by the first distance changing module.

17. The method according to claim 15 further comprising sensing by a sensor deviation of optics focus and generating the first and second focus correction signals.

18. The method according to claim 15 comprising changing by the second distance changing module a height of the optics.

19. The method according to claim 15 comprising changing by the second distance changing module a height of the optics and a height of the pivot chuck.

20. The method according to claim 15 wherein the joint mechanism defines a pivot point and wherein the method comprises changing by the second distance changing module the distance between the pivot chuck and the optics until a point of the substrate that is immediately above the pivot point is located at a focal point of the optics.

21. The method according to claim 15 further comprising storing by a memory module first focus correction signals that were generated during a certain scan of the substrate; and feeding the first focus correction signals to the first distance changing module during another scan of the substrate.

22. The method according to claim 14 wherein the joint mechanism defines a pivot point that is positioned at a center of the upper chuck portion.

23. The method according to claim 14 wherein the joint mechanism defines a pivot point that is positioned outside a center of the upper chuck portion.

24. The method according to claim 14 wherein the joint mechanism defines a pivot point; wherein a ratio between (a) a first distance between the pivot point and a center of the upper chuck portion, and (b) a second distance between the pivot point and an edge of the upper chuck portion ranges between 0.1 and 10.

25. The method according to claim 14 wherein the inducing of the rotation of the upper chuck portion is performed by the angle changing element and by at least one other angle changing element.

26. The method according to claim 14 wherein the angle changing element is a piezoelectric actuator.
